(19) United States
(12) Patent Application Publication
(10) Pub. No.: US 2022/0318952 A1
(43) Pub. Date: Oct. 6, 2022

(54) REMOTE SUPPORT SYSTEM AND REMOTE SUPPORT METHOD

(71) Applicant: Woven Planet Holdings, Inc., Tokyo (JP)

(72) Inventor: Toshinobu WATANABE, Tokyo (JP)

(73) Assignee: Woven Planet Holdings, Inc., Tokyo (JP)

(21) Appl. No.: 17/700,851

(22) Filed: Mar. 22, 2022

(30) Foreign Application Priority Data
Apr. 6, 2021 (JP) 2021-064859

(51) Int. Cl. G06T 3/40; G05D 1/00

(52) U.S. Cl. CPC G06T 3/4076; G05D 1/0022; G05D 1/0038; G05D 2201/0213

(57) ABSTRACT

A remote support system remotely supports an operation of a moving body based on an image captured by a camera installed on the moving body. The remote support system communicates with the moving body to receive the image captured by the camera. The remote support system determines, based on an input image that is the received image or a corrected image acquired by correcting the received image, whether or not congestion control that reduces an image quality of the image is performed in the moving body. When the congestion control is performed in the moving body, the remote support system apples a super-resolution technique to the input image to improve an image quality of the input image to generate an improved image. Then, the remote support system displays the improved image on a display device.

### CROSS-REFERENCE TO RELATED APPLICATION

This application claims priority to Japanese Patent Application No. 2021-064859 filed on Apr. 6, 2021, the entire contents of which are incorporated by reference herein.

### BACKGROUND

### Technical Field

The present disclosure relates to a technique that remotely supports an operation of a moving body. In particular, the present disclosure relates to a technique of remotely supports the operation of the moving body based on an image captured by a camera installed on the moving body.

### Background Art

Patent Literature 1 discloses a vehicle that is remotely operated. The vehicle captures a moving image and transmits the captured moving image to a remote operation device. An operator issues an instruction regarding driving, braking, or steering of the vehicle based on the moving image displayed on a display of the remote operation device. The vehicle receives the operator instruction from the remote operation device and controls driving, braking, or steering according to the operator instruction. When a communication rate between the vehicle and the remote operation device decreases, the vehicle reduces the amount of information per frame constituting the moving image.

Patent Literature 2 discloses an image processing device for distributing data of ultra-high density (UHD) image contents to a terminal such as a display device capable of ultra-high density representation. The image processing device reduces a resolution of an original ultra-high density image content according to a network transmission speed and transmits it to the terminal. In addition to that, the image processing device divides the original ultra-high density image content into a plurality of regions based on similarity of a distribution of features (e.g., brightness). Then, the image processing device transmits reconstruction information indicating the features for each region to the terminal. The terminal receives the reconstruction information together with the image data of low resolution. Then, the terminal reconstructs the ultra-high density image content from the image data of low resolution by the use of the reconstruction information.

Patent Literature 3 discloses an image transmission system for transmitting an ultra-high definition image having a higher resolution than an HDTV image. The image transmission system divides an ultra high-definition image into a plurality of HDTV images. Then, the image transmission system transmits the plurality of HDTV images in parallel by using a plurality of existing HDTV transmission devices.

Patent Literature 4 discloses a technique for remotely operating a moving body such as an unmanned underwater vehicle. The moving body has an imaging means and transmits image data captured by the imaging means to a remote operation device. When a moving speed of the moving body becomes high, the moving body increases a frame rate of the image data and decreases a resolution of the image data.

Non-Patent Literature 1 discloses a “super-resolution technique” that converts an input low-resolution image into a high-resolution image. In particular, Non-Patent Literature 1 discloses an SRCNN that applies deep learning based on a convolutional neural network (CNN) to the super-resolution (SR). A model for converting (mapping) the input low resolution image into the high resolution image is obtained through the machine learning.

Non-Patent Literature 2 discloses an image recognition technique using ResNet (Deep Residual Net).

Non-Patent Literature 3 discloses a technique of correcting an image by the use of deep learning. In particular, Non-Patent Literature 3 discloses a technique (EnlightenGAN) that converts a low-light image into a normal-light image. Using this technique makes it possible to correct an image captured in a scene such as night and glare to be brighter to improve its visibility.

### LIST OF RELATED ART

Patent Literature 1: Japanese Laid-Open Patent Application Publication No. JP-2014-071778
Patent Literature 2: Japanese Laid-Open Patent Application Publication No. JP-2019-121836
Patent Literature 3: Japanese Laid-Open Patent Application Publication No. JP-2007-172318
Patent Literature 4: Japanese Laid-Open Patent Application Publication No. JP-2019-134383
Non Patent Literature 1: Chao Dong, Chen Change Loy, Kaiming He, and Xiaoou Tang, “Image Super-Resolution Using Deep Convolutional Networks”, arXiv: 1501.00092v3 [cs.CV], Jul. 31, 2015 (https://arxiv.org/pdf/1501.00092.pdf)
Non Patent Literature 2: Kaiming He, Xiangyu Zhang, Shaoqing Ren, and Jian Sun, “Deep Residual Learning for Image Recognition”, arXiv: 1512.03385v1 [cs.CV], Dec. 10, 2015 (https://arxiv.org/pdf/1512.03385.pdf)
Non Patent Literature 3: Yifan Jiang, Xinyu Gong, Ding Liu, Yu Cheng, Chen Fang, Xiaohui Shen, Jianchao Yang, Pan Zhou, and Zhangyang Wang, “EnlightenGAN: Deep Light Enhancement without Paired Supervision”, arXiv: 1906.06972v1 [cs.CV], Jun. 17, 2019 (https://arxiv.org/pdf/1906.06972.pdf)

### SUMMARY

In order to remotely support an operation of a moving body such a vehicle and a robot, an image (moving image, static image) captured by a camera installed on the moving body is useful. The image captured by the camera is transmitted from the moving body to a remote support system through communication. An operator looks at the image displayed on a display device of the remote support system to grasp a situation around the moving body and remotely supports the operation of the moving body. Here, if an image quality of the image displayed on the display device is reduced, accuracy of the remote support may be decreased.

According to the technique disclosed in Patent Literature 1 described above, when the communication rate decreases, the amount of information per frame constituting the moving image is reduced. As a result, an image quality of the moving image presented to the operator is reduced. This leads to a decrease in accuracy of the remote support.

An object of the present disclosure is to provide a technique capable of suppressing a decrease in accuracy of a remote support based on an image captured by a camera installed on a moving body.

A first aspect is directed to a remote support system that remotely supports an operation of a moving body based on an image captured by a camera installed on the moving body.

The remote support system includes:

one or more processors; and

a display device.

The one or more processors communicate with the moving body to receive the image captured by the camera.

The one or more processors determine, based on an input image that is the received image or a corrected image acquired by correcting the received image, whether or not congestion control that reduces an image quality of the image is performed in the moving body.

When the congestion control is performed in the moving body, the one or more processors apply a super-resolution technique to the input image to improve an image quality of the input image to generate an improved image and display the improved image on the display device.

A second aspect further has a following feature in addition to the first aspect.

Based on the received image, the one or more processors further identify a scene in which the image is captured.

The one or more processors generate the corrected image by correcting the received image such that a visibility is improved according to the scene.

Then, the one or more processors set the corrected image as the input image.

A third aspect further has a following feature in addition to the first aspect.

The one or more processors receive information of a scene in which the image is captured and that is specified by an operator.

The one or more processors generate the corrected image by correcting the received image such that a visibility is improved according to the scene.

Then, the one or more processors set the corrected image as the input image.

A fourth aspect is directed to a remote support method that remotely supports an operation of a moving body based on an image captured by a camera installed on the moving body.

The remote support method includes:

communicating with the moving body to receive the image captured by the camera;

determining, based on an input image that is the received image or a corrected image acquired by correcting the received image, whether or not congestion control that reduces an image quality of the image is performed in the moving body; and

when the congestion control is performed in the moving body, applying a super-resolution technique to the input image to improve an image quality of the input image to generate an improved image and displaying the improved image on the display device.

A fifth aspect is directed to a remote support system that remotely supports an operation of a moving body based on an image captured by a camera installed on the moving body.

The remote support system includes:

one or more processors; and

a display device.

The one or more processors communicate with the moving body to receive the image captured by the camera.

Based on the received image, the one or more processors identify a scene in which the image is captured.

The one or more processors generate a corrected image by correcting the received image such that a visibility is improved according to the scene.

Then, the one or more processors display the corrected image on the display device.

According to the first aspect, when the congestion control that reduces the image quality of the image is performed in the moving body, the remote support system receiving the image improves the image quality based on the super-resolution technique. Then, the improved image with improved image quality is displayed on the display device. This makes it easier for an operator to accurately grasp a situation around the moving body. Therefore, the decrease in accuracy of the remote support is suppressed.

According to the second and third aspects, the image correction process is performed such that the visibility is improved according to the scene in which the image is captured. This makes it easier for the operator to further accurately grasp the situation around the moving body. Therefore, the decrease in accuracy of the remote support is suppressed.

Moreover, according to the second and third aspects, the corrected image acquired by the image correction process is set as the input image, and then the super-resolution technique is applied to the input image. In other words, the image correction process is performed before the resolution is increased by the super-resolution technique. It is therefore possible to reduce a processing load of the image correction process.

According to the fourth aspect, the same effects as in the first aspect can be obtained.

According to the fifth aspect, an image correction process is performed such that the visibility is improved according to the scene in which the image is captured. Then, the corrected image acquired by the image correction process is displayed on the display device. This makes it easier for an operator to accurately grasp a situation around the moving body. Therefore, the decrease in accuracy of the remote support is suppressed.

### BRIEF DESCRIPTION OF DRAWINGS

FIG. 1 is a conceptual diagram for explaining an outline of a remote support according to a first embodiment of the present disclosure;

FIG. 2 is a conceptual diagram for explaining congestion control in a moving body according to the first embodiment of the present disclosure;

FIG. 3 is a conceptual diagram for explaining an outline of a remote support system according to the first embodiment of the present disclosure;

FIG. 4 is a block diagram showing a configuration example of a moving body according to the first embodiment of the present disclosure;

FIG. 5 is a block diagram showing a configuration example of a remote support system according to the first embodiment of the present disclosure;

FIG. 6 is a block diagram showing a functional configuration example related to an information providing process by the remote support system according to the first embodiment of the present disclosure;

FIG. 7 is a flow chart showing processes performed by a super-resolution processing unit of the remote support system according to the first embodiment of the present disclosure;

FIG. 8 is a block diagram showing a functional configuration example related to an information providing process by a remote support system according to a second embodiment of the present disclosure;

FIG. 9 is a flow chart showing processes performed by a correction processing unit of the remote support system according to the second embodiment of the present disclosure;

FIG. 10 is a block diagram showing a functional configuration example related to an information providing process by a remote support system according to a third embodiment of the present disclosure; and

FIG. 11 is a block diagram showing a functional configuration example related to an information providing process by a remote support system according to a fourth embodiment of the present disclosure.

### EMBODIMENTS

Embodiments of the present disclosure will be described with reference to the accompanying drawings.

### 1. First Embodiment

### 1-1. Outline

### 1-1-1. Outline of Remote Support

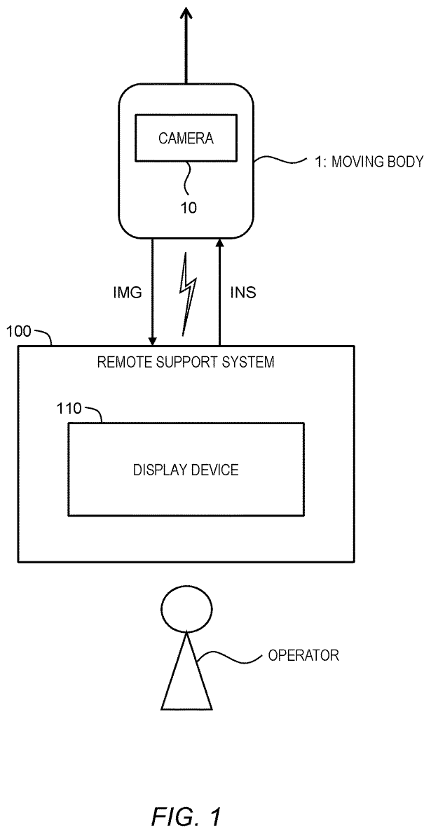

FIG. 1 is a conceptual diagram for explaining an outline of a remote support according to the present embodiment. A moving body 1 is a target of the remote support. Examples of the moving body 1 include a vehicle, a robot, a flying object, and the like. The vehicle may be an automated driving vehicle or a vehicle driven by a driver. Examples of the robot include a logistics robot, a work robot, and the like. Examples of the flying object include an airplane, a drone, and the like.

A camera 10 is installed on the moving body 1. The camera 10 images a situation around the moving body 1 to acquire an image IMG indicating the situation around the moving body 1. The image IMG is typically a moving image, but may be a still image. In the present embodiment, a moving image and a still images are collectively referred to as the “image IMG.”

The moving body 1 and a remote support system 100 is capable of communicating with each other. The remote support system 100 communicates with the moving body 1 and remotely supports an operation of the moving body 1. More specifically, the moving body 1 transmits the image IMG captured by the camera 10. The remote support system 100 receives the image IMG transmitted from the moving body 1. The remote support system 100 includes a display device 110 and displays the image IMG on the display device 110. An operator being a human looks at the image IMG displayed on the display device 110 to grasp the situation around the moving body 1 and remotely support the operation of the moving body 1. Examples of the remote support by the operator include recognition support, judgement support, remote driving, and the like.

As an example, a case where the moving body 1 is an automated driving vehicle is considered. In a situation where the automated driving is difficult, the automated driving vehicle needs the remote support by the operator. For example, when a traffic signal installed at an intersection is exposed to sunlight, accuracy of recognition of signal indication may be deteriorated. If it is not possible to accurately determine the signal indication, the automated driving vehicle needs the operator's remote support for the signal recognition. Moreover, if it is not possible to determine the signal indication, it is also difficult for the automated driving vehicle to decide what action to take at what timing. Therefore, the automated driving vehicle further needs the operator's remote support for the action decision and the timing decision.

When the remote support is necessary, the automated driving vehicle communicates with the remote support system 100 to transmit a support request to the remote support system 100. In response to the support request, the operator determines an operator instruction INS which is an instruction to the automated driving vehicle by referring to the image IMG and the like displayed on the display device 110. Then, the operator inputs the operator instruction INS into the remote support system 100. The remote support system 100 communicates with the automated driving vehicle to notify the automated driving vehicle of the operator instruction INS. The automated driving vehicle resumes the automated driving in accordance with the operator instruction INS.

Alternatively, the operator may remotely drive the automated driving vehicle instead of an automated driving system that controls the autonomous driving vehicle. The operator performs a driving operation including at least one of steering, acceleration, and deceleration by referring to the image IMG and the like displayed on the display device 110. In this case, the operator instruction INS transmitted from the remote support system 100 to the automated driving vehicle indicates contents of the remote driving operation by the operator. The automated driving vehicle performs at least one of steering, acceleration, and deceleration in accordance with the operator instruction INS.

The same applies to a vehicle on which a driver rides. In response to a request from the driver, the operator may remotely drive the vehicle instead of the driver.

As described above, the remote support system 100 performs an “information providing process” that receives information necessary for the remote support such as the image IMG from the moving body 1 and provides that information to the operator. Moreover, the remote support system 100 performs an “operator instruction notification process” that receives the operator instruction INS from the operator and notifies the moving body 1 of the operator instruction INS. That is, the remote support process by the remote support system 100 includes the information providing process and the operator instruction notification process. It can be also said that the remote support system 100 is a system that assists the operator in remotely supporting the moving body 1.

### 1-1-2. Congestion Control

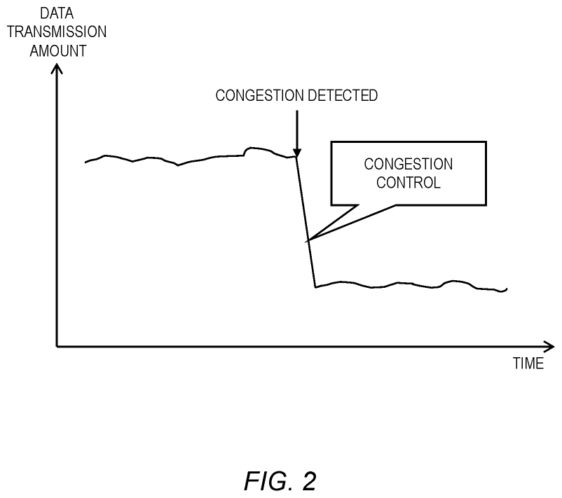

FIG. 2 is a conceptual diagram for explaining congestion control in the moving body 1 according to the present embodiment. The moving body 1 monitors a state of the communication with the remote support system 100 to detect an occurrence of congestion. The congestion detection method is a well known technique and is not particularly limited. For example, the moving body 1 detects the occurrence of congestion based on a packet loss state or a delay state.

When the congestion occurs and a communication rate decreases, the moving body 1 performs the “congestion control” in order to suppress a communication delay and to avoid a communication disruption. More specifically, the moving body 1 reduces a data transmission amount by reducing an image quality of the image IMG to be transmitted to the remote support system 100. Typically, the moving body 1 reduces a resolution of the image IMG to be transmitted to the remote support system 100. Such the congestion control makes it possible to suppress the communication delay and to avoid the communication disruption.

### 1-1-3. Super-Resolution Process

When the congestion control is performed in the moving body 1, the image quality of the image IMG that the remote support system 100 receives from the moving body 1 is reduced. When the image quality of the image IMG displayed on the display device 110 is reduced, it becomes difficult for the operator to accurately grasp the situation around the moving body 1. As a result, the accuracy of the remote support may be decreased. It is desirable to secure the accuracy of the remote support even when the congestion control is performed in the moving body 1.

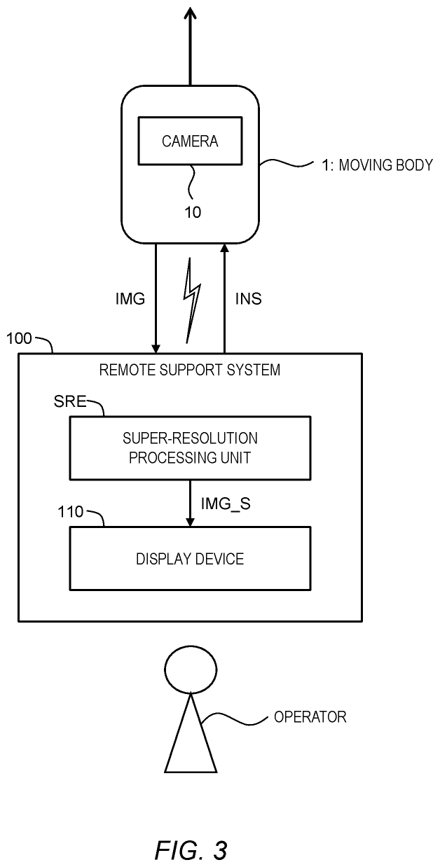

FIG. 3 is a conceptual diagram for explaining an outline of the remote support system 100 according to the present embodiment. The remote support system 100 according to the present embodiment includes a super-resolution processing unit SRE. The super-resolution processing unit SRE determines whether or not the congestion control is performed in the moving body 1 based on the image IMG received from the moving body 1. When it is determined that the congestion control is being performed, the super-resolution processing unit SRE improves the image quality of the image IMG by applying a “super-resolution technique” to the image IMG. The super-resolution technique is able to convert an input low-resolution image into a high-resolution image. Various methods of the super-resolution technique have been proposed (e.g., see Non-Patent Literature 1). In the present embodiment, the method of the super-resolution technique is not particularly limited.

The image IMG whose image quality is improved by the super-resolution technique is hereinafter referred to as an “improved image IMG_S.” When the congestion control is performed, the improved image IMG_S is displayed on the display device 110. This makes it easier for the operator to accurately grasp the situation around the moving body 1. Therefore, the decrease in accuracy of the remote support is suppressed. According to the present embodiment, as described above, it is possible to secure the accuracy of the remote support, even when the congestion occurs in the communication between the moving body 1 and the remote support system 100 and the congestion control is performed,

Hereinafter, the moving body 1 and the remote support system 100 according to the present embodiment will be described in more detail.

### 1-2. Moving Body

### 1-2-1. Configuration Example

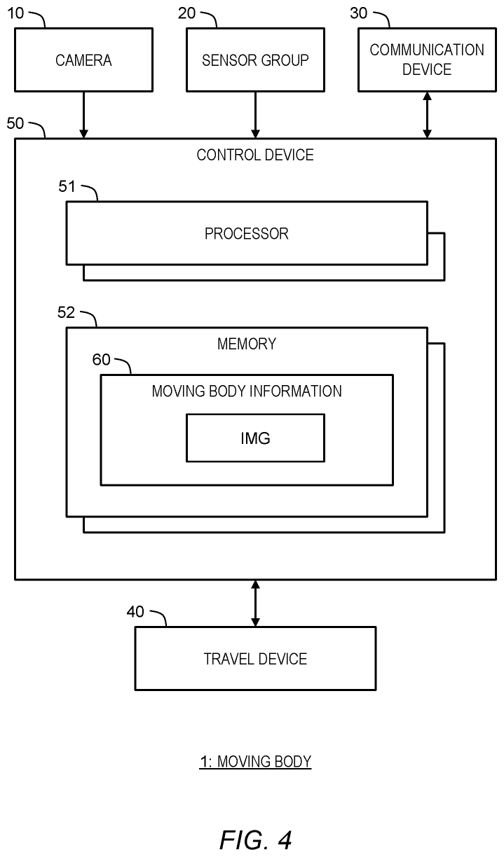

FIG. 4 is a block diagram showing a configuration example of the moving body 1 according to the present embodiment. The moving body 1 includes a camera 10, a sensor group 20, a communication device 30, a travel device 40, and a control device 50. In the present example, the moving body 1 is one having wheels, such as a vehicle and a robot.

The camera 10 images a situation around the moving body 1 to acquire the image IMG indicating the situation around the moving body 1. The image IMG is typically a moving image, but may be a static image.

The sensor group 20 includes a state sensor that detects a state of the moving body 1. The state sensor includes a speed sensor, an acceleration sensor, a yaw rate sensor, a steering angle sensor, and the like. The sensor group 20 also includes a position sensor that detects a position and an orientation of the moving body 1. The position sensor is exemplified by a GPS (Global Positioning System) sensor. Moreover, the sensor group 20 may include a recognition sensor other than the camera 10. The recognition sensor recognizes (detects) the situation around the moving body 1. Examples of the recognition sensor include a LIDAR(Laser Imaging Detection and Ranging), a radar, and the like.

The communication device 30 communicates with the outside of the moving body 1. For example, the communication device 30 communicates with the remote support system 100.

The travel device 40 includes a steering device, a driving device, and a braking device. The steering device turns wheels of the moving body 1. For example, the steering device includes an electric power steering (EPS) device. The driving device is a power source that generates a driving force. Examples of the drive device include an engine, an electric motor, an in-wheel motor, and the like. The braking device generates a braking force.

The control device (controller) 50 controls the moving body 1. The control device 50 includes one or more processors 51 (hereinafter simply referred to as a processor 51) and one or more memories 52 (hereinafter simply referred to as a memory 52). The processor 51 executes a variety of processing. For example, the processor 51 includes a CPU (Central Processing Unit). The memory 52 stores a variety of information. Examples of the memory 52 include a volatile memory, a non-volatile memory, an HDD (Hard Disk Drive), an SSD (Solid State Drive), and the like. The variety of processing by the processor 51 (the control device 50) is implemented by the processor 51 executing a control program being a computer program. The control program is stored in the memory 52 or recorded on a non-transitory computer-readable recording medium. The control device 50 may include one or more ECUs (Electronic Control Units).

### 1-2-2. Moving Body Information

The processor 51 acquires moving body information 60 by using the camera 10 and the sensor group 20. The moving body information 60 is stored in the memory 52.

The moving body information 60 includes surrounding situation information indicating the situation around the moving body 1. The surrounding situation information includes the image IMG that is captured by the camera 10. The surrounding situation information 82 includes object information regarding an object around the moving body 1. Examples of the object around the moving body 1 include a pedestrian, another vehicle (e.g., a preceding vehicle, a parked vehicle, etc.), a sign, a white line, a roadside structure, an obstacle, and the like. The object information indicates a relative position and a relative velocity of the object with respect to the moving body 1. For example, analyzing the image IMG captured by the camera 10 makes it possible to identify the object and calculate the relative position of the object. It is also possible to identify the object and acquire the relative position and the relative velocity of the object, based on the measurement information by the LIDAR and/or the radar.

Moreover, the moving body information 60 includes state information indicating the state of the moving body 1 detected by the state sensor. Furthermore, the moving body information 60 includes position information indicating the position and the orientation of the moving body 1 detected by the position sensor. In addition, the processor 51 may acquire highly accurate position information by performing a well-known localization using map information and the surrounding situation information (the object information).

### 1-2-3. Communication Process

The processor 51 communicates with the remote support system 100 via the communication device 30.

For example, the processor 51 transmits at least a part of the moving body information 60 to the remote support system 100, as necessary. In particular, when the remote support by the operator is necessary, the processor 51 transmits at least a part of the moving body information 60 that includes the image IMG to the remote support system 100. When the support request is made, the processor 51 receives the operator instruction INS from the remote support system 100.

In addition, the processor 51 executes the congestion control described in FIG. 2, as necessary. More specifically, the processor 51 monitors a state of the communication with the remote support system 100 to detect an occurrence of congestion. The congestion detection method is a well known technique and is not particularly limited. For example, the processor 51 detects the occurrence of congestion based on a packet loss state or a delay state. When detecting the occurrence of the congestion, the processor 51 executes the congestion control. More specifically, the processor 51 reduces a data transmission amount by reducing the image quality of the image IMG to be transmitted to the remote support system 100. Typically, the processor 51 reduces a resolution of the image IMG to be transmitted to the remote support system 100. Such the congestion control makes it possible to suppress the communication delay and to avoid the communication disruption.

### 1-2-4. Travel Control

The processor 51 controls travel of the moving body 1. The travel control includes steering control, acceleration control, and deceleration control. The processor 51 executes the travel control by controlling the travel device 40. More specifically, the processor 51 executes the steering control by controlling the steering device. The processor 51 executes the acceleration control by controlling the driving device. The processor 51 executes the deceleration control by controlling the braking device.

The processor 51 may control automated driving of the moving body 1. When performing the automated driving, the processor 51 generates a target trajectory of the moving body 1 based on the moving body information 60. The target trajectory includes a target position and a target velocity. Then, the processor 51 executes the travel control such that the moving body 1 follows the target trajectory.

Further, when receiving the operator instruction INS from the remote support system 100, the processor 51 executes the travel control in accordance with the operator instruction INS.

### 1-3. Remote Support System

### 1-3-1. Configuration Example

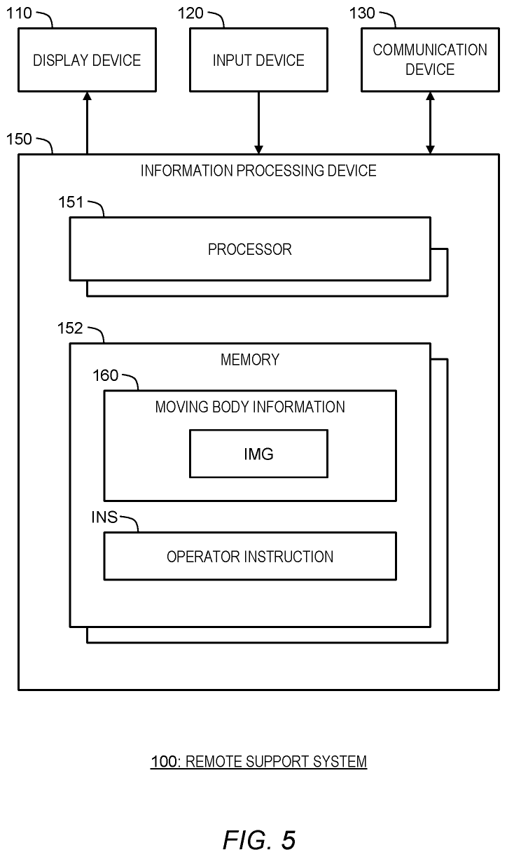

FIG. 5 is a block diagram showing a configuration example of the remote support system 100 according to the present embodiment. The remote support system 100 includes a display device 110, an input device 120, a communication device 130, and an information processing device 150.

The display device 110 displays a variety of information. Examples of the display device 110 include a liquid crystal display, an organic EL display, a head-mounted display, a touch panel, and the like.

The input device 120 is an interface for accepting input from the operator. Examples of the input device 120 include a touch panel, a keyboard, a mouse, and the like. In a case where the remote support is the remote driving, the input device 120 includes a driving operation member used by the operator for performing a driving operation (steering, acceleration, and deceleration).

The communication device 130 communicates with the outside. For example, the communication device 130 communicates with the moving body 1.

The information processing device 150 executes a variety of information processing. The information processing device 150 includes one or more processors 151 (hereinafter simply referred to as a processor 151) and one or more memories 152 (hereinafter simply referred to as a memory 152). The processor 151 executes a variety of processing. For example, the processor 151 includes a CPU. The memory 152 stores a variety of information. Examples of the memory 152 include a volatile memory, a non-volatile memory, an HDD, an SSD, and the like. The functions of the information processing device 150 are implemented by the processor 151 executing a remote support program being a computer program. The remote support program is stored in the memory 152. The remote support program may be recorded on a non-transitory computer-readable recording medium. The remote support program may be provided via a network.

### 1-3-2. Remote Support Process

The processor 151 executes the remote support process that remotely supports the operation of the moving body 1. The remote support processing includes the “information providing process” and the “operator instruction notification process.”

The information providing process is as follows. The processor 151 receives the moving body information 160 necessary for the remote support from the moving body 1 via the communication device 130. The moving body information 160 includes at least a part of the above-described moving body information 60 acquired in the moving body 1. In particular, the moving body information 160 includes at least the image IMG captured by the camera 10 installed on the moving body 1. The moving body information 160 is stored in memory 152. The processor 151 presents the moving body information 160 to the operator by displaying the moving body information 160 on the display device 110.

The operator instruction notification process is as follows. The processor 151 receives the operator instruction INS input by the operator from the input device 120. The operator instruction INS indicates contents of the remote support by the operator. Examples of the remote support by the operator include recognition support, judgement support, remote driving, and the like. For example, the operator instruction INS regarding the remote driving indicates contents of the driving operation by the operator. The processor 151 transmits the operator instruction INS to the moving body 1 via the communication device 130.

### 1-3-3. Details of Information Providing Process

When the above-described congestion control is performed in the moving body 1, the image quality of the image IMG received from the moving body 1 is reduced. When the image quality of the image IMG displayed on the display device 110 is reduced, it becomes difficult for the operator to accurately grasp the situation around the moving body 1. As a result, the accuracy of the remote support may be decreased. In order to improve the image quality of the image IMG displayed on the display device 110, the information providing process according to the present embodiment includes characteristic processes as described below.

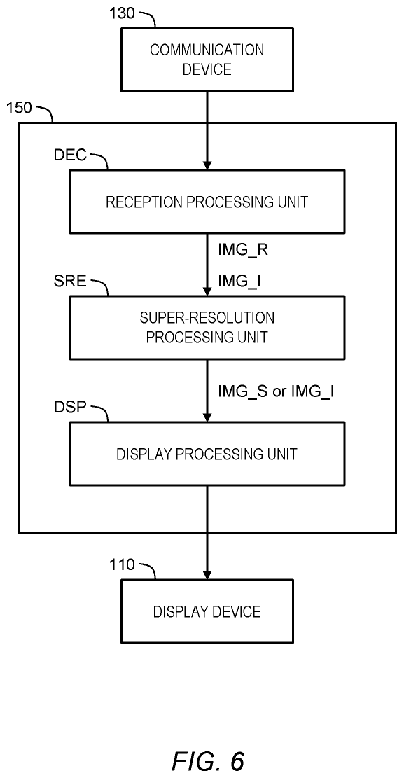

FIG. 6 is a block diagram showing a functional configuration example related to the information providing process according to the present embodiment. The information processing device 150 of the remote support system 100 includes a reception processing unit DEC, a super-resolution processing unit SRE, and a display processing unit DSP as functional blocks. These functional blocks are implemented by the processor 151 executing the remote support program.

The reception processing unit DEC performs a reception process that receives the image IMG from the moving body 1 via the communication device 130. The reception processing unit DEC includes a decoder, and the reception process includes decoding. For convenience sake, the image IMG acquired by the reception process is hereinafter referred to as a “received image IMG_R.”

The received image IMG_R is input to the super-resolution processing unit SRE. For convenience sake, the image input to the super-resolution processing unit SRE is hereinafter referred to as an “input image IMG_I.”. In the example shown in FIG. 6, the input image IMG_I is the received image IMG_R. Another example in which the input image IMG_I is different from the received image IMG_R will be described later.

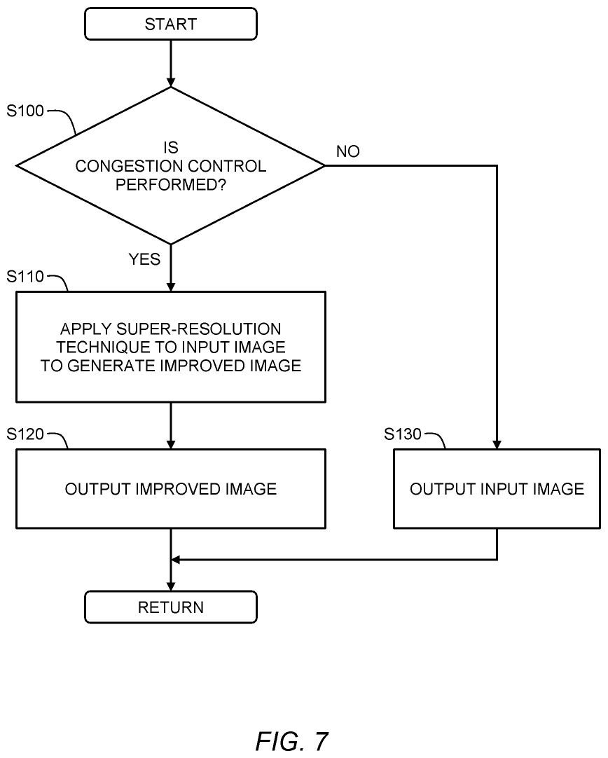

FIG. 7 is a flow chart showing processes performed by the super-resolution processing unit SRE.

In Step S100, the super-resolution processing unit SRE determines, based on the input image IMG_I, whether or not the congestion control is performed in the moving body 1. As shown in the foregoing FIG. 2, when the congestion control is performed, the amount of data transmitted from the moving body 1 to the remote support system 100 is significantly reduced. That is, when the congestion control is performed, a reception bit rate of the input image IMG_I is notably reduced. Therefore, the super-resolution processing unit SRE is able to determine whether or not the congestion control is performed based on a variation of the reception bit rate.

By way of example, a resolution of the original image IMG when the congestion control is not performed is a first resolution. On the other hand, a resolution of the image IMG when the congestion control is performed is a second resolution lower than the first resolution. The second resolution is specified in advance. A first bit rate is a bit rate corresponding to the image IMG with the first resolution. A second bit rate is a bit rate corresponding to the image IMG with the second resolution. A difference between the first bit rate and the second bit rate is significantly larger than a variation width of the bit rate unrelated to the congestion control. In view of the above, the super-resolution processing unit SRE compares the reception bit rate of the input image IMG_I with an average value of the first bit rate and the second bit rate. When the reception bit rate falls below the average value of the first bit rate and the second bit rate, the super-resolution processing unit SRE determines that the congestion control is being performed.

When it is determined that the congestion control is performed (Step S100; Yes), the processing proceeds to Step S110. Otherwise (Step S100; No), the processing proceeds to Step S130.

In Step S110, the super-resolution processing unit SRE applies the super-resolution technique to the input image IMG_I to improve the image quality of the input image IMG_I to generate the improved image IMG_S. Various methods of the super-resolution technique have been proposed (e.g., see Non-Patent Literature 1). In the present embodiment, the method of the super-resolution technique is not particularly limited. After that, the processing proceeds to Step S120.

In Step S120, the super-resolution processing unit SRE outputs the improved image IMG_S to the display processing unit DSP.

In Step S130, the super-resolution processing unit SRE outputs the input image IMG_I as it is to the display processing unit DSP.

The display processing unit DSP displays the improved image IMG_S or the input image IMG_I output from the super-resolution processing unit SRE on the display device 110.

When the congestion control is being performed in the moving body 1, the improved image IMG_S is displayed on the display device 110. This makes it easier for the operator to accurately grasp the situation around the moving body 1. Therefore, the decrease in accuracy of the remote support is suppressed. According to the present embodiment, as described above, it is possible to secure the accuracy of the remote support, even when the congestion control is performed in the moving body 1.

### 2. Second Embodiment

A second embodiment is different from the first embodiment in contents of the information providing process. The basic configurations of the moving body 1 and the remote support system 100 are the same as in the case of the first embodiment. A description overlapping with the first embodiment will be omitted as appropriate.

In the second embodiment, we focus on a scene in which the image IMG is captured. When the image IMG is captured in a specific scene such as night and glare, the image IMG becomes difficult to see. That is, a visibility of the image IMG is decreased and thus it becomes difficult for the operator to accurately grasp the situation around the moving body 1. As a result, the accuracy of the remote support may be decreased. In view of the above, in the second embodiment, correction of the image IMG is performed in the information providing process in order to improve the visibility.

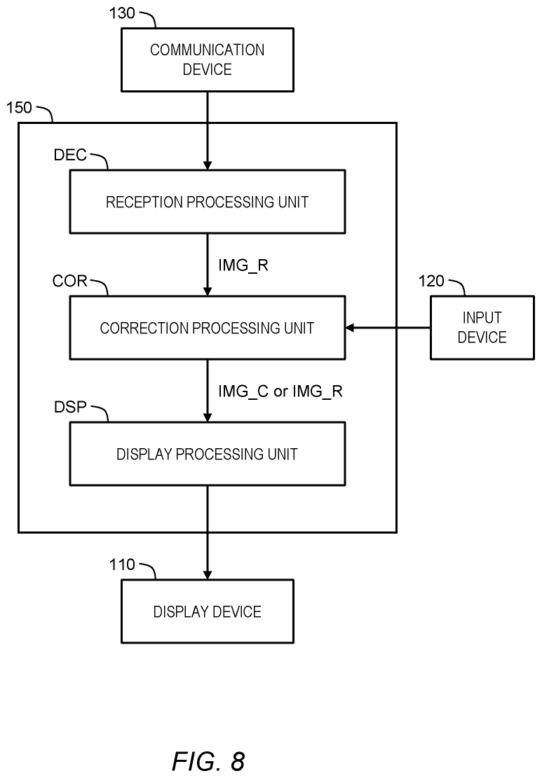

FIG. 8 is a block diagram showing a functional configuration example related to the information providing process according to the second embodiment. The information processing device 150 of the remote support system 100 includes the reception processing unit DEC, a correction processing unit COR, and the display processing unit DSP as functional blocks. These functional blocks are implemented by the processor 151 executing the remote support program. The reception processing unit DEC and the display processing unit DSP are the same as in the case of the first embodiment.

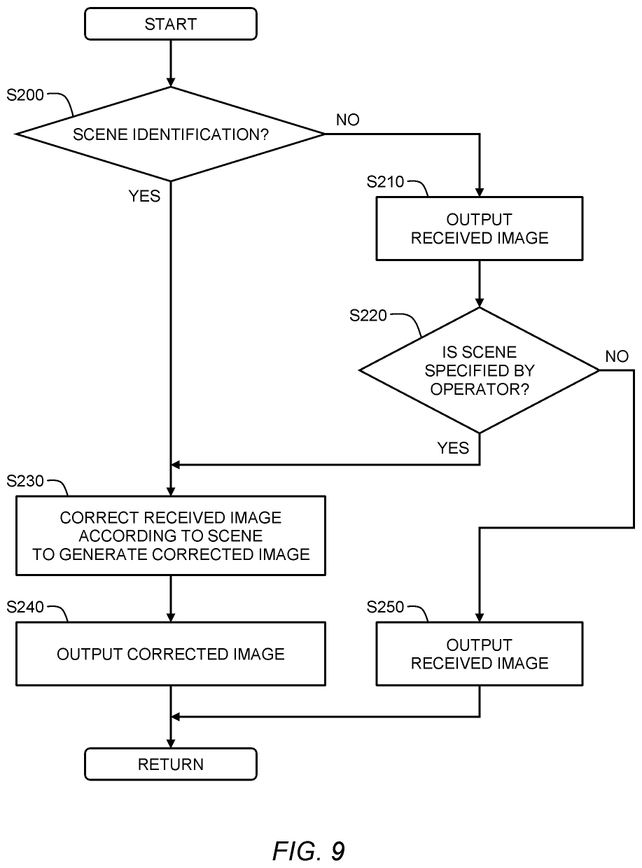

FIG. 9 is a flow chart showing processes performed by the correction processing unit COR according to the second embodiment.

In Step S200, the correction processing unit COR tries to automatically identify the scene in which the image IMG is captured, based on the received image IMG_R. The scene to be identified here is one that causes decrease in the visibility of the image IMG. Examples of such scenes include night, glare, rain, fog, snow, and the like. For example, an image recognition technique based on deep learning is used for the scene identification. For example, the scene in which the image IMG is captured is identified by the image recognition technique disclosed in the above-mentioned Non-Patent Literature 2.

When the scene in which the image IMG is captured is automatically identified (Step S200; Yes), the processing proceeds to Step S230. On the other hand, when the scene in which the image IMG is captured cannot be automatically identified (Step S200; No), the processing proceeds to Step S210.

In Step S210, the correction processing unit COR outputs the received image IMG_R to the display processing unit DSP. As a result, the received image IMG_R is displayed on the display device 110. The operator looking at the received image IMG_R displayed on the display device 110 may possibly desire improvement of visibility. In that case, the operator identifies the scene and specifies the identified scene by the use of the input device 120 to request improvement of visibility.

In Step S220, the correction processing unit COR determines whether or not information of the scene specified by the operator is received from the input device 120. When the information of the scene specified by the operator is received (Step S220; Yes), the processing proceeds to Step S230. Otherwise (Step S220; No), the processing proceeds to Step S250.

In Step S230, the correction processing unit COR corrects the received image IMG_R such that the visibility is improved according to the scene. The image generated by the correction is hereinafter referred to as a “corrected image IMG_C.” For example, an image correction technique based on deep learning is used for the image correction. For example, utilizing the technique disclosed in Non-Patent Literature 3 makes it possible to correct an image captured in a scene such as night and glare to be brighter to improve its visibility. Well-known techniques are also used for the image correction in adverse weather conditions such as rain, fog, and snow. After that, the processing proceeds to Step S240.

In Step S240, the correction processing unit COR outputs the corrected image IMG_C to the display processing unit DSP.

In Step S250, the correction processing unit COR outputs the received image IMG_R as it is to the display processing unit DSP.

The display processing unit DSP displays the corrected image IMG_C or the received image IMG_R output from the correction processing unit COR on the display device 110.

As described above, according to the second embodiment, when the image IMG is captured in such a scene that decreases the visibility, the image correction process is performed such that the visibility is improved. The corrected image IMG_C generated consequently is displayed on the display device 110. This makes it easier for the operator to accurately grasp the situation around the moving body. Therefore, the decrease in accuracy of the remote support is suppressed.

### 3. Third Embodiment

A third embodiment is a combination of the first embodiment and the second embodiment. A description overlapping with the foregoing embodiments will be omitted as appropriate.

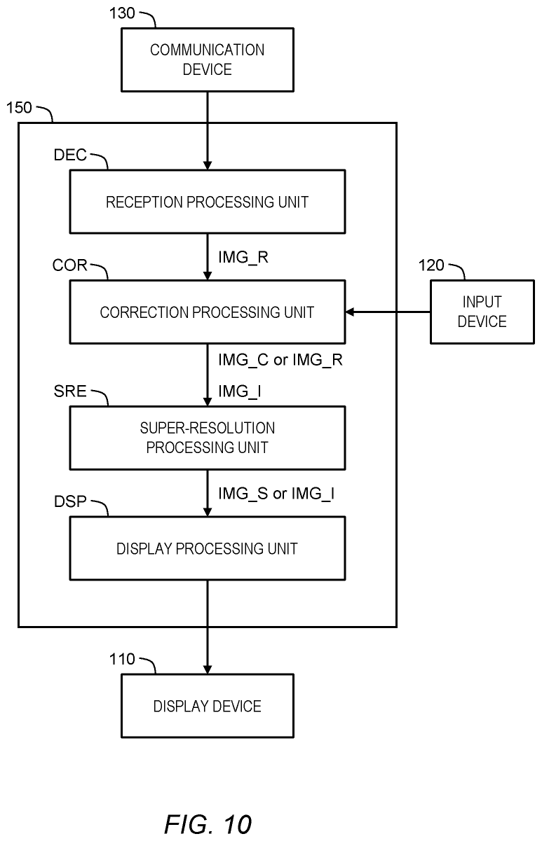

FIG. 10 is a block diagram showing a functional configuration example related to the information providing process according to the third embodiment. The information processing device 150 of the remote support system 100 includes the reception processing unit DEC, the correction processing unit COR, the super-resolution processing unit SRE, and the display processing unit DSP as functional blocks.

The reception processing unit DEC outputs the received image IMG_R to the correction processing unit COR. The correction processing unit COR executes the processing described in the second embodiment and outputs the corrected image IMG_C or the received image IMG_R to the super-resolution processing unit SRE. That is, in the present embodiment, the input image IMG_I input to the super-resolution processing unit SRE is set to the corrected image IMG_C or the received image IMG_R.

Based on the input image IMG_I, the super-resolution processing unit SRE executes the processing described in the first embodiment. Then, the super-resolution processing unit SRE outputs the improved image IMG_S or the input image IMG_I to the display processing unit DSP. The display processing unit DSP displays the improved image IMG_S or the input image IMG_I output from the super-resolution processing unit SRE on the display device 110.

According to the third embodiment, both the effect according to the first embodiment and the effect according to the second embodiment can be obtained.

It should be noted that according to the third embodiment, the processing by the correction processing unit COR is executed before the processing by the super-resolution processing unit SRE. This order of processing is preferable in terms of reduction in processing load. That is, the correction processing unit COR utilizes the image recognition technique and the image correction technique based on the deep learning or the like. The processing load of such the image recognition and the image correction becomes lighter as an input image size becomes smaller. It is therefore possible to reduce the processing load by performing the image recognition and the image correction before the resolution increases by the super-resolution technique.

### 4. Fourth Embodiment

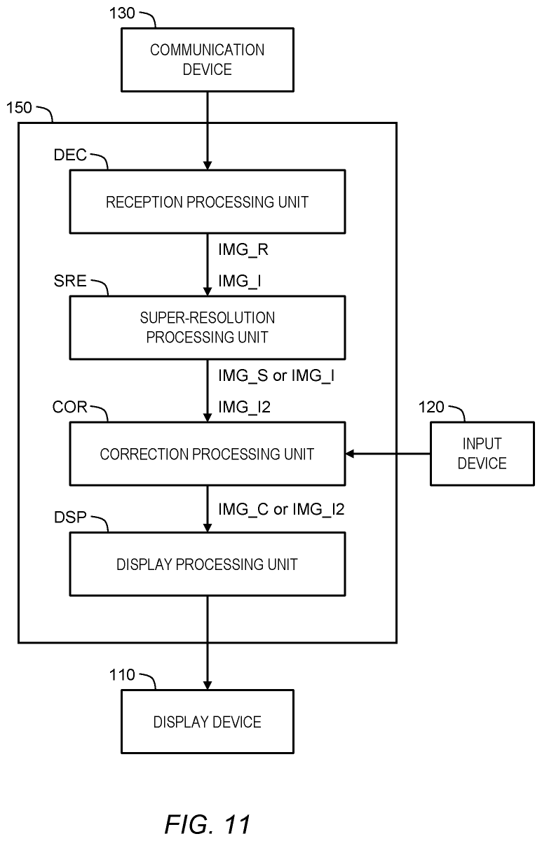

FIG. 11 is a block diagram showing a functional configuration example related to the information providing process according to a fourth embodiment. In the fourth embodiment, the order of the processing by the correction processing unit COR and the processing by the super-resolution processing unit SRE is opposite to that in the case of the third embodiment.

The reception processing unit DEC outputs the received image IMG_R to the super-resolution processing unit SRE. That is, the input image IMG_I input to the super-resolution processing unit SRE is set to the received image IMG_R. The super-resolution processing unit SRE outputs the improved image IMG_S or the input image IMG_I to the correction processing unit COR. That is, an input image IMG_I2 input to the correction processing unit COR is the improved image IMG_S or the input image IMG_I (i.e., the received image IMG_R). The correction processing unit COR outputs the corrected image IMG_C or the input image IMG_I2 to the display processing unit DSP. The display processing unit DSP displays the corrected image IMG_C or the input image IMG_I2 on the display device 110.

Both the effect according to the first embodiment and the effect according to the second embodiment can be obtained by the fourth embodiment as well.

What is claimed is:

1. A remote support system that remotely supports an operation of a moving body based on an image captured by a camera installed on the moving body,
the remote support system comprising:
one or more processors; and
a display device, wherein
the one or more processors are configured to:
communicate with the moving body to receive the image captured by the camera;
determine, based on an input image that is the received image or a corrected image acquired by correcting the received image, whether or not congestion control that reduces an image quality of the image is performed in the moving body; and
when the congestion control is performed in the moving body, apply a super-resolution technique to the input image to improve an image quality of the input image to generate an improved image and display the improved image on the display device.

2. The remote support system according to claim 1, wherein
the one or more processors are further configured to:
identify, based on the received image, a scene in which the image is captured;
generate the corrected image by correcting the received image such that a visibility is improved according to the scene; and
set the corrected image as the input image.

3. The remote support system according to claim 1, wherein
the one or more processors are further configured to:
receive information of a scene in which the image is captured and that is specified by an operator;
generate the corrected image by correcting the received image such that a visibility is improved according to the scene; and
set the corrected image as the input image.

4. The remote support system according to claim 2, wherein
the scene is any of night, glare, rain, fog, and snow.

5. A remote support method that remotely supports an operation of a moving body based on an image captured by a camera installed on the moving body,
the remote support method comprising:
communicating with the moving body to receive the image captured by the camera;
determining, based on an input image that is the received image or a corrected image acquired by correcting the received image, whether or not congestion control that reduces an image quality of the image is performed in the moving body; and
when the congestion control is performed in the moving body, applying a super-resolution technique to the input image to improve an image quality of the input image to generate an improved image and displaying the improved image on the display device.
